(19) United States
(12) Patent Application Publication
(10) Pub. No.: US 2026/0219797 A1
(43) Pub. Date: Jul. 30, 2026

(54) System and Method for Mapping Unaligned Virtual Layer Pages for Sector Aligned Deduplication

(71) Applicant: Dell Products L.P., Round Rock, TX (US)

(72) Inventors: Michael P. Wahl, Bulverde, TX (US); Vamsi K. Vankamamidi, Hopkinton, MA (US); Maor Rahamim, Ramla (IL)

(21) Appl. No.: 19/037,781

(22) Filed: Jan. 27, 2025

(51) Int. Cl. G06F 3/06

(52) U.S. Cl. CPC G06F 3/0641; G06F 3/0608; G06F 3/0673

(57) ABSTRACT

A method, computer program product, and computing system for detecting a set of sector aligned virtual layer pages within a virtual layer within a storage system. An offset for the set of sector aligned virtual layer pages relative to page alignment of a physical address space within the storage system is determined. The offset for the set of sector aligned virtual layer pages is encoded within a logical mapping layer. Deduplication is performed on the set of sector aligned virtual layer pages using the offset for the set of sector aligned virtual layer pages and a linked list of user data pages associated with the set of sector aligned virtual layer pages.

### BACKGROUND

Storing and safeguarding electronic content may be beneficial in modern business and elsewhere. Accordingly, various methodologies may be employed to protect and distribute such electronic content.

For example, storage systems persist data related to host input/output (IO) write requests. These requests may contain data associated with the applications running on the host. There are applications which store identical data sequences at different locations. However, those locations may not be aligned on the storage system's internal page boundary. As such, these IO patterns may be missed by deduplication operations performed on underlying user data pages maintained by the storage system.

### SUMMARY OF DISCLOSURE

In one example implementation, a computer-implemented method executed on a computing device may include, but is not limited to, detecting a set of sector aligned virtual layer pages within a virtual layer within a storage system. An offset for the set of sector aligned virtual layer pages relative to page alignment of a physical address space within the storage system is determined. The offset for the set of sector aligned virtual layer pages is encoded within a logical mapping layer. Deduplication is performed on the set of sector aligned virtual layer pages using the offset for the set of sector aligned virtual layer pages and a linked list of user data pages associated with the set of sector aligned virtual layer pages.

One or more of the following example features may be included. Performing deduplication on the set of sector aligned virtual layer pages may include: identifying page aligned duplicates within the plurality of user data pages associated with the set of sector aligned virtual layer pages; identifying sector aligned duplicates within the plurality of user data pages associated with the set of sector aligned virtual layer pages; and updating a reference count associated with the sector aligned duplicates. A read operation may be performed for the plurality of user data pages associated with the set of sector aligned virtual layer pages. Performing the read operation may include reading the encoded offset for the set of sector aligned virtual layer pages from the virtual layer. Performing the read operation may include reading the plurality of user data pages associated with the set of sector aligned virtual layer pages by processing the encoded offset for the set of sector aligned virtual layer pages. Garbage collection may be performed by maintaining the linked list of user data pages associated with the set of sector aligned virtual layer pages. The linked list of user data pages associated with the set of sector aligned virtual layer pages may include a non-physically contiguous list of user data pages.

In another example implementation, a computer program product resides on a computer readable medium that has a plurality of instructions stored on it. When executed by a processor, the instructions cause the processor to perform operations that may include, but are not limited to, detecting a set of sector aligned virtual layer pages within a virtual layer within a storage system. An offset for the set of sector aligned virtual layer pages relative to page alignment of a physical address space within the storage system is determined. The offset for the set of sector aligned virtual layer pages is encoded within a logical mapping layer. Deduplication is performed on the set of sector aligned virtual layer pages using the offset for the set of sector aligned virtual layer pages and a linked list of user data pages associated with the set of sector aligned virtual layer pages.

One or more of the following example features may be included. Performing deduplication on the set of sector aligned virtual layer pages may include: identifying page aligned duplicates within the plurality of user data pages associated with the set of sector aligned virtual layer pages; identifying sector aligned duplicates within the plurality of user data pages associated with the set of sector aligned virtual layer pages; and updating a reference count associated with the sector aligned duplicates. A read operation may be performed for the plurality of user data pages associated with the set of sector aligned virtual layer pages. Performing the read operation may include reading the encoded offset for the set of sector aligned virtual layer pages from the virtual layer. Performing the read operation may include reading the plurality of user data pages associated with the set of sector aligned virtual layer pages by processing the encoded offset for the set of sector aligned virtual layer pages. Garbage collection may be performed by maintaining the linked list of user data pages associated with the set of sector aligned virtual layer pages. The linked list of user data pages associated with the set of sector aligned virtual layer pages may include a non-physically contiguous list of user data pages.

In another example implementation, a computing system includes at least one processor and at least one memory architecture coupled with the at least one processor, wherein the at least one processor is configured to detect a set of sector aligned virtual layer pages within a virtual layer within a storage system. An offset for the set of sector aligned virtual layer pages relative to page alignment of a physical address space within the storage system is determined. The offset for the set of sector aligned virtual layer pages is encoded within a logical mapping layer. Deduplication is performed on the set of sector aligned virtual layer pages using the offset for the set of sector aligned virtual layer pages and a linked list of user data pages associated with the set of sector aligned virtual layer pages.

One or more of the following example features may be included. Performing deduplication on the set of sector aligned virtual layer pages may include: identifying page aligned duplicates within the plurality of user data pages associated with the set of sector aligned virtual layer pages; identifying sector aligned duplicates within the plurality of user data pages associated with the set of sector aligned virtual layer pages; and updating a reference count associated with the sector aligned duplicates. A read operation may be performed for the plurality of user data pages associated with the set of sector aligned virtual layer pages. Performing the read operation may include reading the encoded offset for the set of sector aligned virtual layer pages from the virtual layer. Performing the read operation may include reading the plurality of user data pages associated with the set of sector aligned virtual layer pages by processing the encoded offset for the set of sector aligned virtual layer pages. Garbage collection may be performed by maintaining the linked list of user data pages associated with the set of sector aligned virtual layer pages. The linked list of user data pages associated with the set of sector aligned virtual layer pages may include a non-physically contiguous list of user data pages.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a sector aligned deduplication process coupled to a distributed computing network according to one or more example implementations of the disclosure;

FIGS. 2-3 are example diagrammatic views of the storage system of FIG. 1 according to one or more example implementations of the disclosure;

FIG. 4 is an example flowchart of the sector aligned deduplication process of FIG. 1 according to one or more example implementations of the disclosure; and

FIG. 5 is an example diagrammatic view of the sector aligned deduplication process of FIG. 1 according to one or more example implementations of the disclosure.

Like reference symbols in the various drawings indicate like elements.

### DETAILED DESCRIPTION

### System Overview

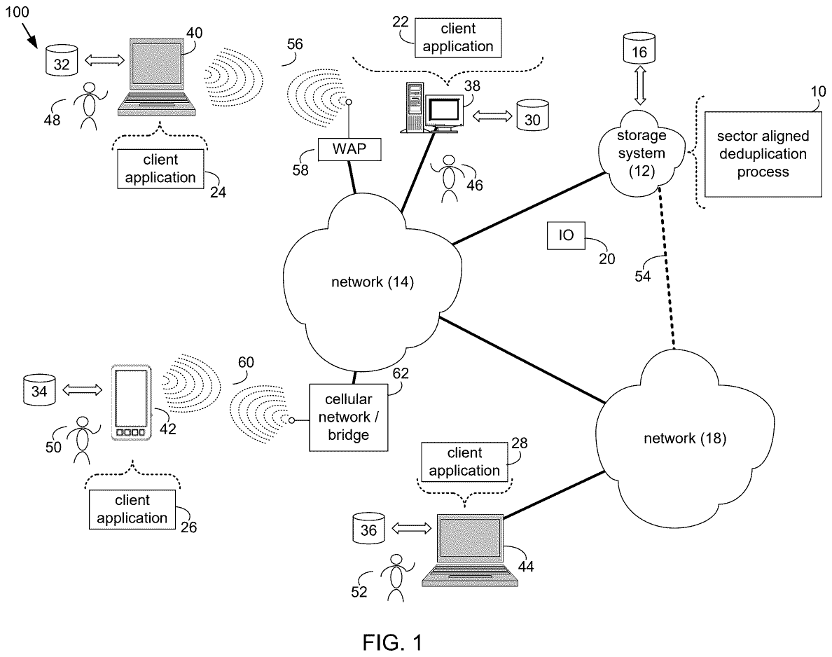

Referring to FIG. 1, there is shown sector aligned deduplication process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of sector aligned deduplication process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of sector aligned deduplication process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a sector aligned deduplication process, such as sector aligned deduplication process 10 of FIG. 1, may include but is not limited to, detecting a set of sector aligned virtual layer pages within a virtual layer within a storage system. An offset for the set of sector aligned virtual layer pages relative to page alignment of a physical address space within the storage system is determined. The offset for the set of sector aligned virtual layer pages is encoded within a logical mapping layer. Deduplication is performed on the set of sector aligned virtual layer pages using the offset for the set of sector aligned virtual layer pages and a linked list of user data pages associated with the set of sector aligned virtual layer pages.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

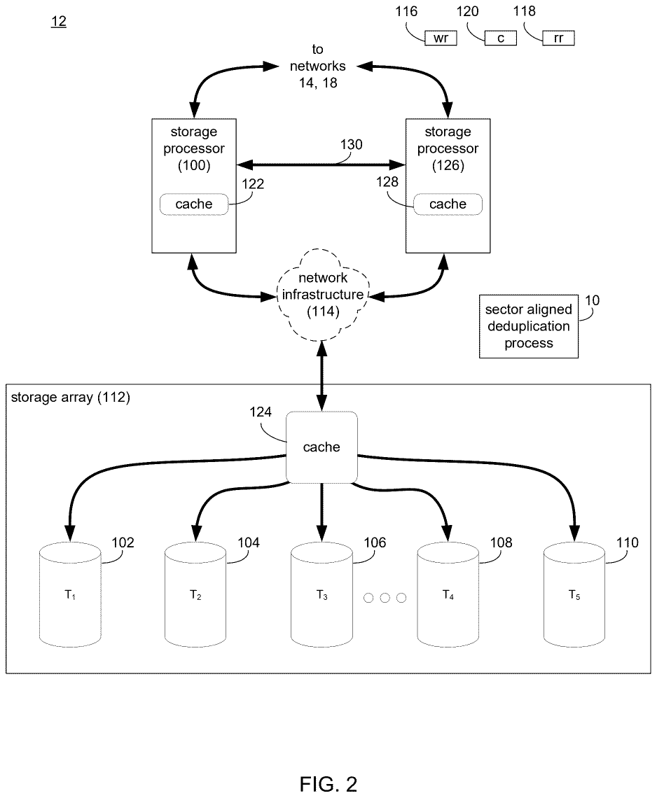

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of sector aligned deduplication process 10. The instruction sets and subroutines of sector aligned deduplication process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of sector aligned deduplication process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of sector aligned deduplication process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of sector aligned deduplication process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of sector aligned deduplication process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of sector aligned deduplication process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### Metadata Architecture

In the context of storage systems, metadata may generally include useful internal information managed by a storage array to describe and locate user data. All modern arrays abstract the physical media and present logical (virtualized) addresses to clients in the form of LUNs. The mapping between the logical address and physical address is a form of metadata that the array needs to manage. That is typically the most common form of metadata for SAN storage systems. Newer architectures manage additional metadata to implement additional capabilities. For example, snapshots, change tracking for efficient remote replication, deduplication pointers, and compression all involve managing some form of metadata.

The classic metadata structure of traditional storage systems directly links a Logical Address of a block to the physical location of the block. In this metadata structure, every logical block written, has a physical block linked directly to it. In addition, as most traditional storage systems were architected for a spinning disk storage medium optimized for sequential writes the address of the logical address affects the physical location that the data is stored. This can lead to an unbalanced storage array that can suffer from hot-spots as specific address space ranges may experience more performance/input-output operations per second (IOPs) than other address space ranges.

Embodiments of the present disclosure may support a flash/random access medium. For example, embodiments of the present disclosure may include a metadata structure that completely decouples the Logical Block Address space address from the physical one. This is done by leveraging a multi-layer architecture.

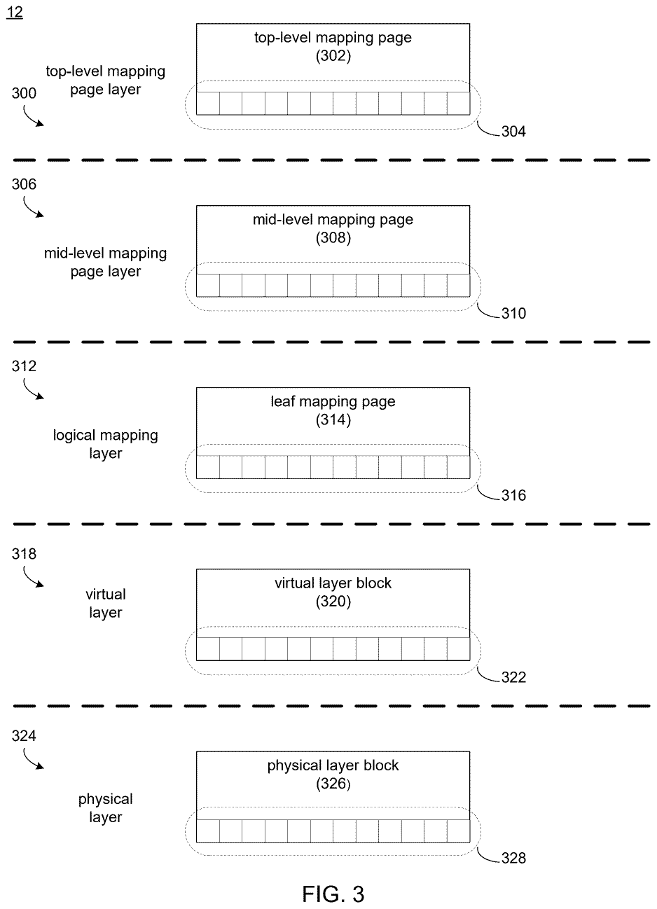

Referring also to FIG. 3, a storage system may generally include a mapper layer which is structured as a file system with various layers of pages and blocks. In some implementations, the combination of various metadata layers mapper layers may be referred to as a mapper metadata tree. While the following example includes metadata “blocks”, it will be appreciated that other units of data storage may be used within the scope of the present disclosure. In some implementations, a top-level mapping page layer (e.g., top-level mapping page layer 300) may include top-level mapping page pages (e.g., top-level mapping page 302) with a plurality of entries (e.g., plurality of entries 304) that map or point to a plurality of entries of one or more mid-level mapping pages. A mid-level mapping page layer (e.g., mid-level mapping page layer 306) may include mid-level mapping page pages (e.g., mid-level mapping page 308) with a plurality of entries (e.g., plurality of entries 310) that map or point to a plurality of entries of one or more leaf mapping pages. A logical mapping layer (e.g., logical mapping layer 312) may include leaf mapping page pages (e.g., leaf mapping page 314) with a plurality of entries (e.g., plurality of entries 316) that map or point to a plurality of entries of one or more virtual layer blocks. Logical mapping layer 312 may represent various ranges of Logical Block Addresses (LBAs). For example, each entry of the plurality of entries (e.g., plurality of entries 316) of the leaf mapping page (e.g., leaf mapping page 314) may be associated with a LBA range. In some implementations, the combination of top-level mapping page layer 300, mid-level mapping page layer 306, and logical mapping layer 312 may be organized in a “tree” data structure where each leaf mapping page is a “leaf” of the “tree” data structure that corresponds to a specific LBA range. Accordingly, each leaf mapping page (e.g., leaf mapping page 314) may hold a mapping of a LBA to a virtual layer block. It will be appreciated that other data structures may be used within the scope of the present disclosure to organize the first layer.

In some implementations, a virtual layer (e.g., second layer 318) may include virtual layer blocks (e.g., virtual layer block 320) with a plurality of entries (e.g., plurality of entries 322) that map to a plurality of entries of one or more physical layer blocks. The virtual layer (e.g., virtual layer 318) may generally isolate the logical address of a block from the physical location of the block. For example, a virtual layer block (e.g., virtual layer block 308) may encapsulate the physical location of user data and allow relocation without updating leaf mapping pages (e.g., leaf mapping page 314). Accordingly, the virtual layer (e.g., virtual layer 318) may decouple the Logical Block Address space address from the physical one. In some implementations, virtual layer blocks (e.g., virtual layer block 320) are also referred to as “virtual layer pages” within the scope of the present disclosure.

In some implementations, a physical layer (e.g., physical layer 324) may include physical layer blocks (e.g., physical layer block 326) with a plurality of entries or portions (e.g., plurality of entries 328) that are configured to store user data. In this manner, physical layer 324 may describe the physical location of user data in a storage system. In some implementations, each physical layer block (e.g., physical layer block 326) may have a predefined amount of storage capacity for storing data (e.g., user data). In some implementations, physical layer blocks (e.g., physical layer block 326) are also referred to as “user data pages” within the scope of the present disclosure.

### The Sector Aligned Deduplication Process

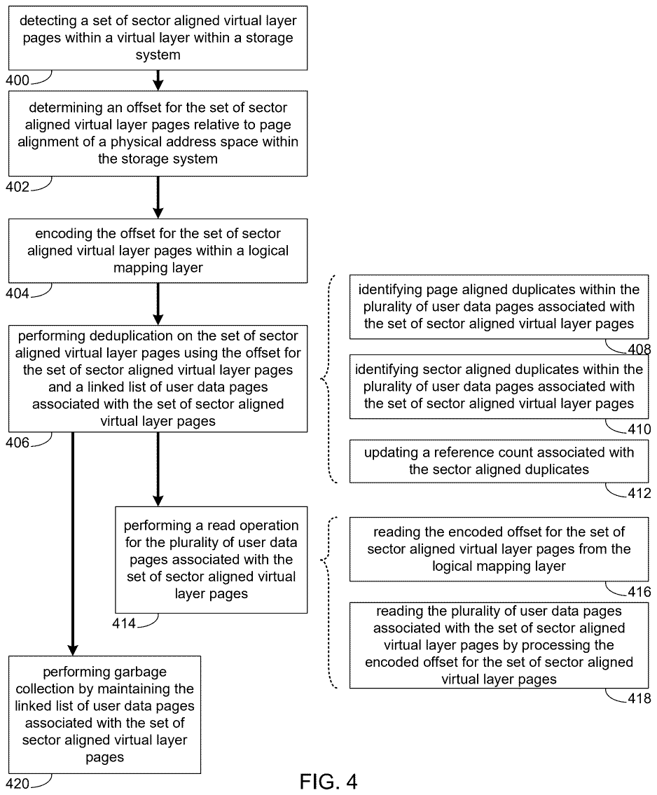

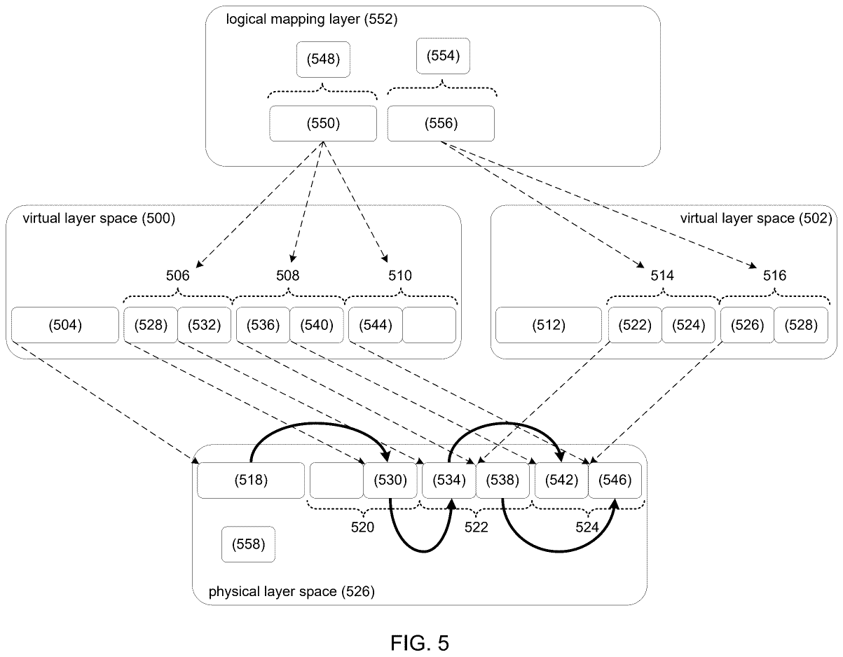

Referring also to FIGS. 4-5 and in some implementations, sector aligned deduplication process 10 detects 400 a set of sector aligned virtual layer pages within a virtual layer within a storage system. An offset for the set of sector aligned virtual layer pages relative to page alignment of a physical address space within the storage system is determined 402. The offset for the set of sector aligned virtual layer pages is encoded 404 within a logical mapping layer. Deduplication is performed 406 on the set of sector aligned virtual layer pages using the offset for the set of sector aligned virtual layer pages and a linked list of user data pages associated with the set of sector aligned virtual layer pages.

In some implementations, sector aligned deduplication process 10 detects 400 a set of sector aligned virtual layer pages within a virtual layer within a storage system. As discussed above, storage systems persist data related to host input/output (IO) write requests. These requests may contain data associated with the applications running on the host. There are applications which store identical data sequences at different locations. However, those locations may not be aligned on the storage system's internal page boundary. As such, these IO patterns may be missed by deduplication operations performed on underlying user data pages maintained by the storage system.

The identical data sequences may, however, be aligned on a sector-level boundary. Introducing sector-aligned deduplication covers this case; thereby, increasing the storage system's overall deduplication ratio. The concept can be extended beyond sector alignment to any arbitrary offset. A user data page whose data is an identical copy of the user's data elsewhere in the storage system where that data is not aligned with the storage system's internal page size thus corresponds to portions of the data from two of the storage system's internal user data pages. That is, a user data page detected as aligned by some offset will be duplicated across two sequential pages, such that the duplicate page is formed from content from both user data pages given the offset. While examples of “sector” alignments are discussed, it will be appreciated that other alignments of various granularities may be used within the scope of the present disclosure.

Thus, to support non-page-aligned deduplication, the storage system's mapping data structures need to: 1) map the user data page to another data page that contains the first part of the former's data; 2) the mapping needs to contain the offset within the other data page where the user's data starts; and 3) the mapping needs to have a linkage from that data page to the logically next data page.

Implementations of the present disclosure provide an efficient mapping approach for non-page-aligned deduplication which avoids extra levels of indirection, avoids maintaining additional hashes, and minimizes impact on host performance while providing a deterministic algorithm for capturing all the opportunities of sector-aligned deduplication.

For example, for data sequences that align on the storage system's page boundaries, page-aligned deduplication can occur. Referring also to FIG. 5, two virtual layer spaces (e.g., virtual layer spaces 500, 502) within virtual layer 318 include a plurality of virtual layer pages (e.g., virtual layer pages 504, 506, 508, 510 in virtual layer space 500 and virtual layer pages 512, 514, 516 in virtual layer space 502). In some implementations, virtual layer space 500 represents a portion of logical address space within storage system 12 and virtual layer space 502 represents a separate portion of logical address space within storage system 12. In this example, virtual layer page 504 represents a virtual layer page that is aligned with a user data page (e.g., user data page size). In one example, each user data page (e.g., user data pages 518, 520, 522, 524) within physical layer space 526 of storage system 12 is e.g., four kilobytes. In another example, each user data page is e.g., eight kilobytes. However, it will be appreciated that the user data pages may be of any size within the scope of the present disclosure.

In some implementations, different logical addresses can map to the same physical location inside the storage system. For example, virtual layer page 504 maps to user data page 518. However, virtual layer page 506 maps to user data pages 520, 522. Specifically, sector 528 of virtual layer page 506 maps to sector 530 of user data page 520 and sector 532 of virtual layer page 506 maps to sector 534 of user data page 522. Similarly, sector 536 of virtual layer page 508 maps to sector 538 of user data page 522; sector 540 of virtual layer page 508 maps to sector 542 of user data page 524; and sector 544 of virtual layer page 510 maps to sector 546 of user data page 524. In this example, the shift of mapping between virtual layer pages 506, 508, and 510 is sector-aligned, where each sector is a predefined portion of the virtual layer page. In some implementations, sector aligned deduplication process 10 detects 400 a set of sector aligned virtual layer pages by determining that a virtual layer page is not page aligned with the user data pages of storage system 12 but is aligned with a sector size. In this example, sector aligned deduplication process 10 determines that virtual layer page 506 is not page aligned with user data page 520 but is sector aligned with sector 528 of virtual layer page 506 mapping to sector 530 of user data page 520 and sector 532 of virtual layer page 506 mapping to sector 534 of user data page 522. Sector aligned deduplication process 10 detects 400 the set of sector aligned virtual layer pages (e.g., virtual layer pages 506, 508, 510) based on the sector aligned mappings to user data pages 520, 522, 524.

In some implementations, sector aligned deduplication process 10 determines 402 an offset for the set of sector aligned virtual layer pages relative to page alignment of a physical address space within the storage system. With sector aligned mappings, these mappings cannot align with the storage system's internal pages and thus cannot be deduplicated by conventional deduplication approaches. This situation can be partially addressed by having the mapping from the logical addresses of the virtual layer to the physical storage location(s) with an offset in the physical user data page where the logical data starts. Accordingly, sector aligned deduplication process 10 determines 402 an offset for each virtual layer page by comparing the mapping of each virtual layer page relative to page alignment of the physical layer space (e.g., physical layer space 526). In the example of FIG. 5, sectors 530, 538, and 546 represent an offset of half of the page size. However, it will be appreciated that various and distinct offsets may be determined for each sector aligned virtual layer page within the scope of the present disclosure.

In some implementations, sector aligned deduplication process 10 encodes 404 the offset for the set of sector aligned virtual layer pages within a logical mapping layer. For example, the offset may be a number or range of address space within physical layer space for mapping a particular sector within a virtual layer page to a starting position for the corresponding data within a sector of a user data page. In some implementations, sector aligned deduplication process 10 encodes 404 this offset (e.g., offset 548) within a leaf page (e.g., leaf page 550) of a logical mapping layer (e.g., logical mapping layer 552) for virtual layer pages 506, 508, 510. Similarly, sector aligned deduplication process 10 encodes 404 offset 554 within leaf page 556 for virtual layer pages 514, 516. With offsets 548, 550 encoded in virtual layer spaces 500, 502, sector aligned deduplication process 10 can obtain these offsets for accessing the starting position for the corresponding user data pages without requiring additional read operations to the physical layer space.

As discussed above, if the same data is stored multiple times but at different offsets relative to the user data pages, there would need to be multiple entries in the virtual layer (e.g., one for each offset). Such an implementation impacts garbage collection (and/or the amount of metadata that needs to be maintained) because: 1) in order to move the physical location of a user data page, all of the virtual entries pointing to that user data page would need to be modified; and 2) in order to determine that a physical user data page is eligible for reclaiming, all of the virtual entries pointing to that user data page would need to have no logical layer references to them. In some implementations, this is a signification issue for sector-alignment offsets used for deduplication. However, this presents a greater issue for finer granularity alignment offsets possible within the scope of the present disclosure.

In some implementations, sector aligned deduplication process 10 addresses this issue by defining a single, primary virtual layer page that points to the physical location and have the sector-aligned (or finer granularity) deduplicated virtual entries (with their respective encoded offsets) point to the primary virtual layer page. This allows for “content-aligned” deduplication (i.e., deduplication aligned with particular content or different granularities than sectors). The drawback is that to read the deduplicated data, access to multiple virtual layer pages (as the deduplicated virtual layer pages point to the primary virtual layer page which points to the user data page(s) containing the data) is required. This has performance implications since, more than likely, the deduplicated virtual layer page(s) and the primary virtual layer page reside in separate metadata blocks on the physical storage media.

In some implementations, sector aligned deduplication process 10 removes the need for using multiple virtual layer pages for a read operation that likely requires reading multiple virtual metadata blocks from storage) by encoding 404 the offset for a sector-aligned deduplicated page to the “leaf” page (e.g., leaf page 550) of the logical mapping layer (e.g., logical mapping layer 552). In some implementations, this approach is used for finer alignment granularities than sectors.

In some implementations, sector aligned deduplication process 10 performs 406 deduplication on the set of sector aligned virtual layer pages using the offset for the set of sector aligned virtual layer pages and a linked list of user data pages associated with the set of sector aligned virtual layer pages. Deduplication is the process of consolidating duplicate user data pages associated with separate virtual layer pages. Referring again to FIG. 5, suppose virtual layer block 508 maps to sector 538 of user data page 522 and sector 546 of user data page 524 and that virtual layer block 514 maps to user data pages including the same content (not shown). In this example, sector aligned deduplication process 10 performs 406 deduplication on the set of sector aligned virtual layer pages (e.g., virtual layer pages 508 and 514) using the offset (e.g., offsets 548, 554) and a linked list of user data pages associated with the set of sector aligned virtual layer pages. For example, in addition to determining the user data pages in the physical layer space where the logical data starts, sector aligned deduplication process 10 needs to determine where the remainder of the logical data resides. To this end, blocks or pages of user data within the physical layer space that are part of the same data sequence written to the storage system, are linked together in a linked list to allow for sector aligned deduplication process 10 to determine what user data page follows another. In one example, the linked list is maintained in virtual layer. In another example, the linked list is maintained in the physical layer.

In some implementations, the linked list of user data pages associated with the set of sector aligned virtual layer pages includes a non-physically contiguous list of user data pages. Referring again to FIG. 5, sectors 518, 530, 534, and 542 form a linked list of user data pages that are non-physically contiguous as other data is written to other sectors while sectors 518 and 530 were written. Similarly, user data page 538 and 546 form a separate non-physically contiguous list of user data pages. In this manner, sector aligned deduplication process 10 is able to determine where user data starts using the offset and where the rest of the user data is using the linked list.

In some implementations, performing 406 deduplication on the set of sector aligned virtual layer pages includes: identifying 408 page aligned duplicates within the plurality of user data pages associated with the set of sector aligned virtual layer pages; identifying 410 sector aligned duplicates within the plurality of user data pages associated with the set of sector aligned virtual layer pages; and updating 412 a reference count associated with the sector aligned duplicates. For example, when performing deduplication on a newly written user data sequence, sector aligned deduplication process 10 first identifies 408 page-aligned duplicates. Afterwards, the remaining portion(s) of the data sequence which are at least two pages in length are checked for sector aligned duplicates to identify 410 sector aligned duplicates. For example, sector aligned deduplication process 10 moves through each portion a sector-at-a-time, calculating the hash for that page of data and checking for a match against the existing page-aligned hashes. In some implementations, sector aligned deduplication process 10 may be configured to only look at a subset of the possible sector offsets at the time of flushing user data pages and to check the remaining during subsequent deduplication processing. If a user data page is unique, only the page-aligned hash is added to the deduplication index. None of the hashes calculated as part of the sector-aligned deduplication processing are added to the deduplication index.

In some implementations, when a user data page is found to be a sector-aligned duplicate of already written data, it is comprised of portions of two user data pages on the physical storage. As such, sector aligned deduplication process 10 updates 412 a reference count associated with the plurality of user data pages. Referring again to the example of FIG. 5, sector aligned deduplication process 10 identifies 410 sector aligned duplicates in sector 536 of virtual layer page 508 and sector 522 of virtual layer page 514; and sector 540 of virtual layer page 508 and sector 524 of virtual layer page 514 for sector 538 of user data page 522 and sector 542 of user data page 524. In this example, sector aligned deduplication process 10 updates 412 the reference count (e.g., reference count 558) for the sector aligned duplicates.

In some implementations, sector aligned deduplication process 10 performs 414 a read operation for the plurality of user data pages associated with the set of sector aligned virtual layer pages. For example and as discussed above, for a user data page which is determined to be a sector-aligned duplicate, the offset into the user data page (as well as the physical storage location) is stored in the logical mapping layer. In this manner, sector aligned deduplication process 10 determines the offset from the logical mapping layer and the physical storage location from the virtual layer. As such, no additional level of indirection is needed compared to when a virtual mapping object is used between the virtual layer and the physical layer to hold the sector offset (and the physical storage location with which the sector offset is to be used).

In some implementations, performing 414 the read operation includes reading 416 the encoded offset for the set of sector aligned virtual layer pages from the logical mapping layer and reading 418 the plurality of user data pages associated with the set of sector aligned virtual layer pages by processing the encoded offset for the set of sector aligned virtual layer pages. For example, sector aligned deduplication process 10 performs a read operation for user data pages associated with virtual layer page 506 by reading 416 encoded offset 548 from logical mapping layer 552 and processing 418 encoded offset 548 to identify the starting position (i.e., sector 530 of user data page 520). Further, since the physical storage locations associated with a data sequence are linked together, the read knows where to find the rest of the data it needs as it needs data from two physical storage locations to form the complete user data block. Using the linked list, sector aligned deduplication process 10 reads sector 532 from sector 534 of user data page 522. In some implementations, target user data pages are typically deep compressed where multiple user data pages are compressed together. Accordingly, although sector aligned requires reading two physical storage locations, the user data pages may be in the same deep-compressed block and hence not add additional read/decompression overhead.

In some implementations, sector aligned deduplication process 10 performs 420 garbage collection by maintaining the linked list of user data pages associated with the set of sector aligned virtual layer pages. As discussed above, user data pages, which are part of the same data sequence written to the storage system, are linked together in a linked list. The user data pages of physical storage do not need to be physically contiguous on the storage. Accordingly, even though they may have been physically contiguous when first written, garbage collection is able to rearrange the physical locations in a non-contiguous manner by maintaining the data sequence linkages without impacting the ability to read any associated sector-aligned deduplicated user data block. In some implementations, when there is a virtual mapping object to allow garbage collection to rearrange the mapping between the logical layer and physical layer such that they are not physically contiguous, the data sequence linkage is retained in the same virtual mapping object, so that there is no “redirection” overhead of reading an additional virtual mapping object.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
detecting a set of sector aligned virtual layer pages within a virtual layer within a storage system;
determining an offset for the set of sector aligned virtual layer pages relative to page alignment of a physical address space within the storage system;
encoding the offset for the set of sector aligned virtual layer pages within a logical mapping layer; and
performing deduplication on the set of sector aligned virtual layer pages using the offset for the set of sector aligned virtual layer pages and a linked list of user data pages associated with the set of sector aligned virtual layer pages.

2. The computer-implemented method of claim 1, wherein performing deduplication on the set of sector aligned virtual layer pages includes:
identifying page aligned duplicates within the plurality of user data pages associated with the set of sector aligned virtual layer pages;
identifying sector aligned duplicates within the plurality of user data pages associated with the set of sector aligned virtual layer pages; and
updating a reference count associated with the sector aligned duplicates.

3. The computer-implemented method of claim 1, further comprising:
performing a read operation for the plurality of user data pages associated with the set of sector aligned virtual layer pages.

4. The computer-implemented method of claim 3, wherein performing the read operation includes reading the encoded offset for the set of sector aligned virtual layer pages from the logical mapping layer.

5. The computer implemented method of claim 4, wherein performing the read operation includes reading the plurality of user data pages associated with the set of sector aligned virtual layer pages by processing the encoded offset for the set of sector aligned virtual layer pages.

6. The computer implemented method of claim 1, further comprising:
performing garbage collection by maintaining the linked list of user data pages associated with the set of sector aligned virtual layer pages.

7. The computer implemented method of claim 6, wherein the linked list of user data pages associated with the set of sector aligned virtual layer pages includes a non-physically contiguous list of user data pages.

8. A computer program product residing on a non-transitory computer readable medium having a plurality of instructions stored thereon which, when executed by a processor, cause the processor to perform operations comprising:
detecting a set of sector aligned virtual layer pages within a virtual layer within a storage system;
determining an offset for the set of sector aligned virtual layer pages relative to page alignment of a physical address space within the storage system;
encoding the offset for the set of sector aligned virtual layer pages within a logical mapping layer; and
performing deduplication on the set of sector aligned virtual layer pages using the offset for the set of sector aligned virtual layer pages and a linked list of user data pages associated with the set of sector aligned virtual layer pages.

9. The computer program product of claim 8, wherein performing deduplication on the set of sector aligned virtual layer pages includes:
identifying page aligned duplicates within the plurality of user data pages associated with the set of sector aligned virtual layer pages;
identifying sector aligned duplicates within the plurality of user data pages associated with the set of sector aligned virtual layer pages; and
updating a reference count associated with the sector aligned duplicates.

10. The computer program product of claim 9, wherein the operations further comprise:
performing a read operation for the plurality of user data pages associated with the set of sector aligned virtual layer pages.

11. The computer program product of claim 10, wherein performing the read operation includes reading the encoded offset for the set of sector aligned virtual layer pages from the logical mapping layer.

12. The computer program product of claim 11, wherein performing the read operation includes reading the plurality of user data pages associated with the set of sector aligned virtual layer pages by processing the encoded offset for the set of sector aligned virtual layer pages.

13. The computer program product of claim 8, wherein the operations further comprise:
performing garbage collection by maintaining the linked list of user data pages associated with the set of sector aligned virtual layer pages.

14. The computer program product of claim 13, wherein the linked list of user data pages associated with the set of sector aligned virtual layer pages includes a non-physically contiguous list of user data pages.

15. A computing system comprising:
a memory; and
a processor configured to detect a set of sector aligned virtual layer pages within a virtual layer within a storage system, to determine an offset for the set of sector aligned virtual layer pages relative to page alignment of a physical address space within the storage system, to encode the offset for the set of sector aligned virtual layer pages within a logical mapping layer, and to perform deduplication on the set of sector aligned virtual layer pages using the offset for the set of sector aligned virtual layer pages and a linked list of user data pages associated with the set of sector aligned virtual layer pages.

16. The computing system of claim 15, wherein performing deduplication on the set of sector aligned virtual layer pages includes:
identifying page sector aligned duplicates within the plurality of user data pages associated with the set of sector aligned virtual layer pages;
identifying sector aligned duplicates within the plurality of user data pages associated with the set of sector aligned virtual layer pages; and
updating a reference count associated with the sector aligned duplicates.

17. The computing system of claim 16, wherein the processor is further configured to:
perform a read operation for the plurality of user data pages associated with the set of sector aligned virtual layer pages.

18. The computing system of claim 17, wherein performing the read operation includes reading the encoded offset for the set of sector aligned virtual layer pages from the logical mapping layer.

19. The computing system of claim 18, wherein performing the read operation includes reading the plurality of user data pages associated with the set of sector aligned virtual layer pages by processing the encoded offset for the set of sector aligned virtual layer pages.

20. The computing system of claim 15, wherein the processor is further configured to:
perform garbage collection by maintaining the linked list of user data pages associated with the set of sector aligned virtual layer pages.
